(19) United States
(12) Patent Application Publication
(10) Pub. No.: US 2011/0202833 A1
(43) Pub. Date: Aug. 18, 2011

(54) METHOD AND APPARATUS FOR RECOGNIZING EXTERNAL MEMORY IN PORTABLE TERMINAL

(75) Inventors: Sung-Ho JEON, Gyeongsangbuk-do (KR); Seok-Ju KWON, Daegu (KR)

(73) Assignee: SAMSUNG ELECTRONICS CO., LTD., Gyeonggi-Do (KR)

(21) Appl. No.: 13/015,728

(22) Filed: Jan. 28, 2011

(30) Foreign Application Priority Data
Feb. 12, 2010 (KR) 10-2010-0013246

(51) Int. Cl. G06F 3/00

(52) U.S. Cl. 715/700

(57) ABSTRACT

Provided is a method and apparatus for recognizing an external memory in a portable terminal. The method includes sensing an insertion of the external memory and being requested, by a user, to recognize data stored in the external memory, and recognizing the entire stored data while displaying data one at a time or in its entirety depending on the processing speed of the terminal.

### CLAIM OF PRIORITY

This application claims the benefit under 35 U.S.C. §119(a) of a Korean Patent Application filed in the Korean Intellectual Property Office on Feb. 12, 2010 and assigned Serial No. 10-2010-0013246, the entire disclosure of which is hereby incorporated by reference.

### BACKGROUND OF THE INVENTION

1. Field of the Invention

The present invention generally relates to a portable terminal, and more particularly, to a technique for enabling a portable terminal to recognize data from a removable external memory coupled thereto.

2. Description of the Related Art

While the performance of portable terminals has been improved to a higher level with popularization of multi-function and high-performance smart terminals, the demand for basic functions of portable terminals is still high. To meet this demand, low-cost portable terminals are still available in the market.

The low-cost portable terminals inevitably have limited hardware resources to reduce manufacturing cost, for example, a low data processing speed of a controller such as a Central Processing Unit (CPU) or a System On Chip (SOC) providing the same functions as the CPU.

The low-cost portable terminals are typically equipped with a removable external memory. Because of the limited hardware resources, the low-cost portable terminal consumes much time in recognizing and processing data stored in the external memory which is undesirable to a user. In particular, when the capacity of the external memory is large, such as 8GB, 16GB, or 32GB, it takes even more time for the low-cost portable terminal to recognize the external memory.

Therefore, there is a need for a technique which allows a low-cost portable terminal limited in terms of hardware resources to quickly recognize and access data stored in an external memory.

### SUMMARY OF THE INVENTION

Accordingly, an aspect of the present invention is to provide a technique which enables a low-cost portable terminal to quickly recognize an external memory and thus allows a user to readily use the external memory.

According to an aspect of the present invention, a method for recognizing an external memory in a portable terminal includes sensing an insertion of the external memory and being requested, by a user, to recognize data stored in the external memory, and recognizing the entire stored data while displaying data one at a time or in its entirety depending on the processing speed of the terminal.

According to another aspect of the present invention, an apparatus for recognizing an external memory in a portable terminal includes the external memory for storing one or more data and a controller for, upon being requested, by a user, to recognize the data stored in the external memory after sensing of an insertion of the external memory, recognizing the entire stored data while displaying data one at a time or in its entirety depending on the processing speed of the terminal.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a block diagram of a portable terminal according to an embodiment of the present invention;

FIG. 2 is a flowchart illustrating a process of recognizing data of an external memory according to an embodiment of the present invention;

FIG. 3 is a first exemplary diagram for describing a process of recognizing data of an external memory according to an embodiment of the present invention; and

FIG. 4 is a second exemplary diagram for describing a process of recognizing data of an external memory according to an embodiment of the present invention.

### DETAILED DESCRIPTION OF THE INVENTION

Hereinafter, an embodiment of the present invention will be described in detail with reference to the accompanying drawings.

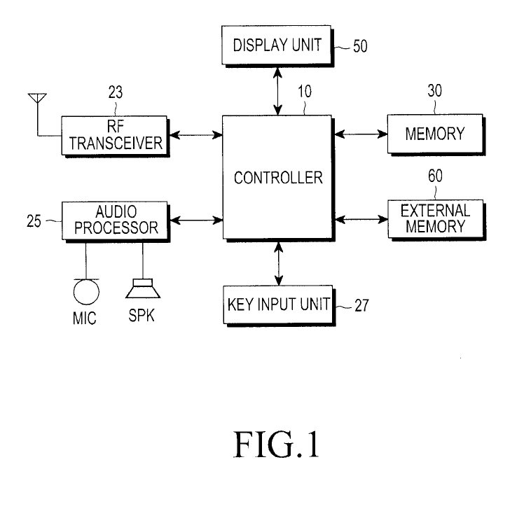

FIG. 1 is a block diagram of a portable terminal according to an embodiment of the present invention.

Referring to FIG. 1, a key input unit 27 includes keys for inputting numeric and character information and functional keys for setting various functions. A user may request a recognition of data stored in an external memory 60 and display of a list of the stored data by using the key input unit 27 according to an embodiment of the present invention.

A Radio Frequency (RF) transceiver 23 for performing a wireless communication function of the portable terminal includes an RF unit and a modem. The RF unit includes an RF transmitter for up-converting a frequency of a transmission signal and amplifying the up-converted transmission signal, and an RF receiver for low-noise-amplifying a received signal and down-converting a frequency of the low-noise-amplified signal. The modem includes a transmitter for encoding and modulating the transmission signal and a receiver for demodulating and decoding the received signal.

An audio processor 25 may constitute a codec including a data codec and an audio codec. The data codec processes packet data and the audio codec processes audio signals like voice and a multimedia file. The audio processor 25 also converts a digital audio signal received from the modem into an analog audio signal through the audio codec and reproduces the analog audio signal, or converts an analog audio signal generated from a microphone (MIC) into a digital audio signal through the audio codec and transmits the digital audio signal to the modem. The codec may be separately provided or may be included in a controller 10 of the portable terminal.

A memory 30 includes a Read Only Memory (ROM) and a Random Access Memory (RAM). The memory 30 may include program memories and data memories and store programs for controlling an operation of the portable terminal and data for booting.

A display unit 50 displays an image signal and user data on a screen or displays data associated with communication. The display unit 50 may include a Liquid Crystal Display (LCD), an Organic Light Emitting Diodes (OLED), or an Active Matrix Organic Light Emitting Diodes (AMOLED). When the LCD, OLED, or AMOLED is implemented with a touch screen, the display unit 50 may operate as an input unit for controlling the portable terminal, together with the key input unit 27. Thus, the display unit 50 may serve as an input unit for controlling the portable terminal, together with the key input unit 27, by including a touch screen. The display unit 50 according to an embodiment of the present invention displays the list of the data stored in the external memory 60.

The external memory 60 indicates a memory removable from the portable terminal and may include a flash memory. Examples of the external memory 60 may include a Compact Flash (CF), a Secure Digital (SD), a micro-SD, a mini-SD, an Extreme Digital (xD), a memory stick, and so forth. It should be noted that other memory known to artisian may be applicable according to the teachings of the present invention.

A controller 10 controls the overall operation of the portable terminal. The controller 10 according to an embodiment of the present invention, upon being requested to recognize (check) the data stored in the external memory 60, recognizes the stored data and displays the stored data on the display unit 50.

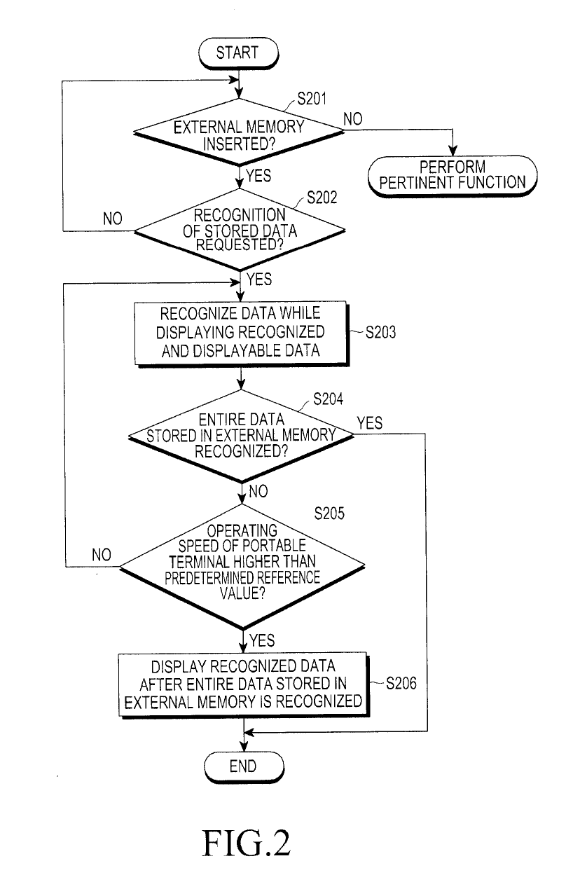

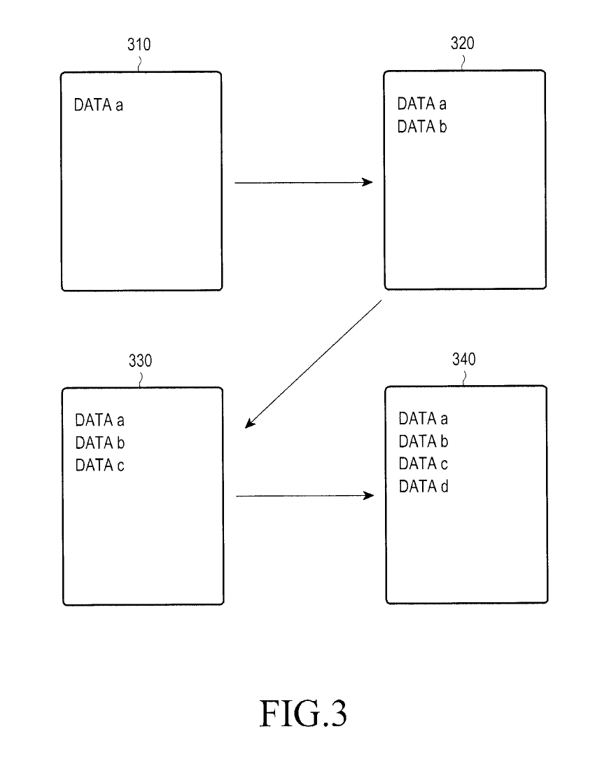

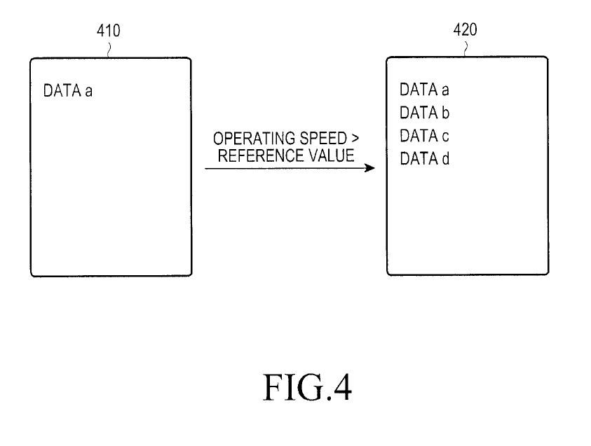

FIG. 2 is a flowchart illustrating a process of recognizing data of the external memory 60 according to an embodiment of the present invention, FIG. 3 is a first exemplary diagram for describing the process of recognizing data of the external memory 60 according to an embodiment of the present invention, and FIG. 4 is a second exemplary diagram for describing the process of recognizing data of the external memory 60 according to an embodiment of the present invention.

Hereinafter, an embodiment of the present invention will be described with reference to FIGS. 1 through 4.

In steps S201 through S203, the controller 10, upon being requested to recognize (or check) data stored in the external memory 60 after insertion of the external memory 60 into the portable terminal, recognizes the stored data while displaying the recognized data.

With reference to FIG. 3, a detailed description will now be made of steps S201 through S203 on the assumption that the data stored in the external memory 60 includes four data, data a, data b, data c, and data d and the order of recognition of the stored data is data a -> data b -> data c -> data d.

When the data a is first recognized, the controller 10 according to an embodiment of the present invention displays the recognized data a as indicated by 310 of FIG. 3. Thereafter, once the data b is recognized, the controller 10 displays the data b together with the first recognized data a as indicated by 320 of FIG. 3. Once the data c is recognized, the controller 10 displays the data recognized prior to recognition of the data c, that is, the data a and the data b, together with the recognized data c as indicated by 330 of FIG. 3. Once the data d is recognized, the controller 10 then displays the data recognized prior to recognition of the data d, that is, the data a, the data b, and the data c, together with the recognized data d as indicated by 340 of FIG. 3.

When compared to a conventional technique where after recognition of the entire data stored in the external memory 60, the recognized entire data is displayed at a time, the embodiment of the present invention described through steps S201 through S203 solves a problem of causing the user's inconvenience of waiting until the completion of recognition of the entire data. In addition, the embodiment of the present invention described through steps S201 through S203 immediately displays the recognized data, allowing the user to easily access the data displayed first.

While requesting the controller 10 to recognize the stored data in step S202 is assumed to be rerequested by the user during operation, an insertion of the external memory 60 itself may also be regarded as requesting of the recognition of the stored data. Therefore, when the user inserts the external memory 60 into the portable terminal, the controller 10 performs steps S202 and S203 to recognize the data stored in the external memory 60.

In steps S204 through S206, if an operating speed of the portable terminal is higher than a predetermined reference value prior to completion of the recognition of the entire data stored in the external memory 60, the controller 10 displays the recognized data after the entire data stored in the external memory 60 is recognized. That is, if an operating speed of the portable terminal is lower than the predetermined reference value in a state where the data a is recognized and displays as indicated by 410 of FIG. 4, and thereafter, if the operating speed is higher than the predetermined reference value, the controller 10 recognizes the not-yet recognized data (the data b, the data c, and the data d) and then displays the recognized data b, c, and d, together with the recognized data a, as indicated by 420 of FIG. 4. When the portable terminal operates at high speed, a short time is consumed in recognizing and displaying the entire data stored in the external memory 60. Therefore, the user convenience may be improved by recognizing and then displaying the entire data stored in the external memory 60 at a time as in steps S204 through S206.

Note that the operating speed of the portable terminal varies with an operating mode of the portable terminal during usage. The operating speed of the portable terminal is also affected by hardware performance of the portable terminal. For example, the operating speed of the portable terminal may be affected by an operating speed of the controller 10 and a data input/output speed of the memory 30 or the external memory 60. Therefore, the predetermined reference value may be a value associated with the operating speed of the portable terminal, such as an operation clock of the controller 10.

In view of above, according to a modification of the embodiment of the present invention, step S204 may be performed prior to step S203, whereby when the portable terminal operates at high speed, the entire data stored in the external memory 60 is recognized at once and then displayed at a time. Thus, depending on processing availability during usage, when the portable terminal operates at high speed or has high hardware performance, the controller 10 may recognize the entire data stored in the external memory 60 and then display the recognized data at a time as in conventional art. That is, according to the operating speed of the portable terminal, the entire data stored in the external memory 60 may be recognized and then displayed at once, or the data stored in the external memory 60 may be recognized and displayed one by one immediately when the recognized data can be displayed.

As is apparent from the foregoing description to those having reasonable skill in this art, the data stored in the external memory can be quickly checked according to the teachings of the present invention. Moreover, the present invention may provide data recognition which varies according to the operating speed of the portable terminal, thereby improving user convenience. The foregoing is to be constructed as only being an illustrative embodiment of this invention. Persons skilled in the art can easily conceive of alternative arrangements providing a functionality similar to this embodiment without any deviation from the fundamental principles or the scope of this invention.

Further, note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the present invention has been described in detail, an embodiment mentioned in the course of description is merely illustrative rather than restrictive and changes in components that can be substituted equivalently in the present invention also fall within the scope of the present invention, without departing from the technical spirit and scope of the invention as provided in the accompanying claims.

What is claimed is:

1. A method for recognizing an external memory in a portable terminal, the method comprising:
sensing an insertion of the external memory or receiving a request, to recognize data stored in the external memory; and
recognizing one data at a time and displaying the one data at a time until the entire data stored in the external memory has been completely recognized and displayed.

2. The method of claim 1, wherein the recognizing of the entire data comprises:
comparing an operating speed of the portable terminal with a predetermined reference value; and
if the operating speed is higher than the predetermined reference value, recognizing the entire stored data then displaying the entire stored data.

3. The method of claim 1, wherein the recognizing of the entire data comprises:
comparing an operating speed of the portable terminal with a predetermined reference value; and
if the operating speed is lower than the predetermined reference value, displaying the entire data stored in the external memory one at a time.

4. The method of claim 3, wherein after displaying a first data, recognizing and displaying the remaining data stored in the external memory at once along with the first data if the operating speed is higher than the predetermined reference value.

5. An apparatus for recognizing one or more data from an external memory of a portable terminal, comprising:
a display; and
a controller for, upon sensing an insertion of the external memory or receiving a request to recognize the data stored in the external memory, recognizing one data at a time and displaying the one data at a time until the entire data is completely recognized and displayed.

6. The apparatus of claim 5, wherein the controller compares an operating speed of the portable terminal with a predetermined reference value, and if the operating speed is lower than the predetermined reference value, the controller recognizes and displays the entire stored data one at a time.

7. The apparatus of claim 6, wherein after displaying a first data, the controller recognizes and displays the remaining data stored in the external memory at once along with the first data if the operating speed is higher than the predetermined reference value.

8. The apparatus of claim 5, wherein the controller compares an operating speed of the portable terminal with a predetermined reference value, and if the operating speed is higher than the predetermined reference value, the controller displays the entire data stored in the external memory at once after completing the recognition of the entire data.
